(19) United States
(12) Patent Application Publication
(10) Pub. No.: US 2026/0159710 A1
(43) Pub. Date: Jun. 11, 2026

(54) Aligned Liquid Crystal Elastomer Structures for Mechanical Damping

(71) Applicant: National Technology & Engineering Solutions of Sandia, LLC, Albuquerque, NM (US)

(72) Inventors: Samuel C. Leguizamon, Albuquerque, NM (US); Devin Roach, Albuquerque, NM (US); Adam W. Cook, Albuquerque, NM (US); Adam Bischoff, Mount Angel, OR (US)

(73) Assignee: Oregon State University, Corvallis, OR (US)

(21) Appl. No.: 18/976,457

(22) Filed: Dec. 11, 2024

(51) Int. Cl. C09D 11/104; B29C 64/118; B29K 67/00; B29K 105/00; B29L 31/00; B33Y 10/00; B33Y 80/00; C09D 11/101; F16F 1/36; F16F 15/08

(52) U.S. Cl. CPC C09D 11/104; B29C 64/118; B33Y 10/00; B33Y 80/00; C09D 11/101; F16F 1/3605; F16F 15/08; B29K 2067/00; B29K 2105/0079; B29K 2995/0091; B29L 2031/774; F16F 2224/025; F16F 2226/04

(57) ABSTRACT

Direct ink write (DIW) 3D printing, an extrusion-based additive manufacturing (AM) approach, is used to prepare aligned, monodomain liquid crystal elastomer (LCE) lattice structures which can be used for multi-strain rate mechanical damping, ranging from quasi-static compression to dynamic shock and vibration. LCE structures can not only dissipate strain energy in quasi-static environments because of their lattice architectures, but also harness the dynamic energy dissipation properties of the aligned, monodomain LCE material. The invention provides a pathway for the simple fabrication of mechanical damping devices that effectively dissipate energy across a broad range of loading rates.

### FEDERALLY SPONSORED RESEARCH AND DEVELOPMENT

This invention was made with Government support under Contract No. DE-NA0003525 awarded by the United States Department of Energy/National Nuclear Security Administration. The Government has certain rights in the invention.

### STATEMENT REGARDING PRIOR DISCLOSURES BY THE INVENTOR OR A JOINT INVENTOR

The following disclosure is submitted under 35 U.S.C. 102 (b) (1) (A): Adam Bischoff, Carter Bawcutt, Maksim Sorkin, Joel Yazzie, Caitlyn C. Cook, Samuel C. Leguizamon, Adam W. Cook, and Devin J. Roach, “Monodomain Liquid-Crystal Elastomer Lattices for Broad Strain-Rate Mechanical Damping,” Advanced Engineering Materials, 2401796 (2024). The subject matter of this disclosure was conceived of or invented by the inventors named in this application.

### BACKGROUND OF THE INVENTION

Mechanical damping properties are an important characteristic of materials and structures, providing vital functions including shock absorption and frequency attenuation for protective equipment, transportation and packaging, as well as soundproofing. See Q. Zhang et al., J. Appl. Packag. Res. 9 (3), 2 (2017); D. Wang and R. Yang, J. Vib. Control 25 (9), 1536 (2019); M. A. Shaid Sujon et al., Polym. Test. 104, 107388 (2021); and A. Kudva et al., Cogent Eng. 9 (1), 2107770 (2022). Traditional approaches for dampening include springs, structural padding, and hydraulic absorption. See P. Dunaj et al., Materials 13 (9), 9 (2020); and H. Marzbani et al., J. Vib. Control 20 (10), 1439 (2014). Recent advances in soft elastic materials such as foams and rubbers have provided new dampening pathways enabled by geometry, molecular structure, and material properties. Elastomers, in particular, have shown promise as mechanical dampeners due to their viscoelastic properties finding widespread implementation in impact protection as a result of their scalable and reversible viscoelastic energy-trapping mechanisms. See S-Y. Jeon et al., Adv. Mater. 34 (14), 2200272 (2022); and S. Shan et al., Adv. Mater. 27 (29), 4296 (2015). One class of elastomer, called liquid crystal elastomers (LCEs), are commonly known for their actuating applications, surface adhesion properties, and biomedical applications. See Y.-Y. Xiao et al., Adv. Intell. Syst. 2 (12), 2000148 (2020); S. Leanza et al., Adv. Funct. Mater. 34 (29), 2400396 (2024); S. Li et al., Sci. Adv. 7 (30), eabg3677 (2021); C. Yuan et al., J. Soft Matter 13 (33), 5558 (2017); Q. He et al., Sci. Adv. 5 (10), eaax5746 (2019); D. J. Roach et al., Smart Mater. Struct. 27 (12), 125011 (2018); M. O. Saed et al., Nat. Commun. 12 (1), 6676 (2021); R. Annapooranan et al., Adv. Funct. Mater. 34 (1), 2309123 (2024); P. A. Pranda et al., ACS Appl. Mater. Interfaces 16 (5), 6394 (2024); J. Uchida et al., Adv. Mater. 34 (23), 2109063 (2022); G. A. R. Rohaley and E. Hegmann, Mater. Adv. 3 (14), 5725 (2022); and S. Tasmim et al., Biomaterials 292, 121912 (2023). Nevertheless, LCEs provide exceptional material-level damping properties that have been mentioned throughout the literature, first observed by de Gennes in 1975, yet have been minimally explored as mechanical dampeners since. See P. G. De Gennes, C. R. Acad. Sci. Ser. B 281, 101 (1975).

Liquid crystal elastomers (LCEs) are cross-linked polymer networks with polymer chains composed of a high concentration of rigid, rod-like segments based on interconnected aromatic or cyclohexyl rings. These rod-like molecular segments are referred to as mesogens. Mesogens can be integrated into the main chain or the side chain of the polymer network. Liquid crystallinity is based on the intermolecular interactions between mesogens. Therefore, LCEs combine the elastic properties of the rubbery polymer network with the anisotropic properties of liquid crystals. See K. M. Herbert et al., Nat. Rev. Mater. 7, 23 (2022).

The macroscopic alignment of mesogens, the polymeric backbone of the LCE, is the key to the unique mechanical properties of LCEs. See D. Mistry et al., J. Appl. Phys. 129 (13), 130901 (2021). Uniaxial alignment creates a monodomain in the material that allows for mesogen rotation upon loading. This creates a plateau region in the stress-strain response where the LCE acts as an ideal absorber, whereby increased strain on the material does not result in increasing stress. Importantly, this response has been observed as rate-dependent, such that as the strain rate increases, the energy absorption density also increases as a power law relationship. See C. P. M. Linares et al., J. Soft Matter 16 (38), 878 (2020); S.-Y. Jeon et al., Adv. Mater. 34 (14), 2200272 (2022); and A. Hotta and E. M. Terentjev, Eur. Phys. J. E 10 (4), 291 (2003). This rate-dependence in energy absorption density is an important factor in monodomain LCEs' ability to provide damping in dynamic environments. See B. Song et al., Mech. Mater. 197, 105986 (2024). However, minimal research has been conducted on LCE damping properties in recent years due to the difficulty of producing viable, macroscopically aligned LCE structures.

Fabricating aligned, monodomain LCEs has primarily remained a challenge due to complicated chemistry. However, recent approaches using photo or mechanical alignment with simple, two-stage chemistry have been shown to produce both mono- and poly-domain nematic LCEs. See P. A. Pranda et al., ACS Appl. Mater. Interfaces 16 (5), 6394 (2024); T. H. Ware et al., Science 347 (6225), 982 (2015); T. Seki, Polym. J. 46 (11), 751 (2014); Y. Guo et al., Adv. Mater. 28 (12), 2353 (2016); and A. Kotikian et al., Adv. Mater. 30 (10), 1706164 (2018). Yakacki et al. presented a simple pathway for macroscopic alignment of LCE using two-stage thiol-acrylate reaction and photopolymerization (TAMAP), where a polydomain LCE sample was strained to temporarily orient the mesogens into a monodomain and crosslinked using UV light. See C. M. Yakacki et al., RSC Adv. 5 (25), 18997 (2015). This work resulted in an explosion of approaches for fabricating aligned LCEs for functional applications. Additive manufacturing (AM), in particular, has stood out as a facile means for LCE alignment that enables the fabrication of structures that are viable for engineering applications. See G. A. R. Rohaley and E. Hegmann, Mater. Adv. 3 (14), 5725 (2022); C. Luo et al., ACS Appl. Mater. Interfaces 13 (11), 12698 (2021); and L. Smith et al., Adv. Mater. Technol. 9 (6), 2301668 (2024). Recent advances in AM have enabled simple fabrication of porous, lattice architectures which are well-suited for mechanical damping applications. See C. M. Yakacki et al., RSC Adv. 5 (25), 18997 (2015); A. Maiti et al., Sci. Rep. 6 (1), 24871 (2016); and A. E. Gongora et al., Matter 5 (9), 2829 (2022). Furthermore, AM provides straightforward control over structural geometries to produce tailorable damping qualities as well as rapid optimization cycles for tailorable mechanical response using machine learning. See A. Maiti et al., Sci. Rep. 6 (1), 24871 (2016); A. E. Gongora et al., Matter 5 (9), 2829 (2022); D. J. Roach et al., Addit. Manuf. 41, 101950 (2021); Z. Wang et al., Addit. Manuf. 52, 102678 (2022); J. Qin et al., Addit. Manuf. 52, 102691 (2022); and X. Qi et al., Engineering 5 (4), 721 (2019). As a result of the advancements in fabricating monodomain LCEs using AM, there is considerable opportunity for the AM of LCE-based lattices as mechanical dampers.

In 2020, Traugutt et al. developed a photocurable liquid crystal resin for use with digital light processing (DLP), a vat-based AM approach, to fabricate complex porous lattice structures. See N. A. Traugutt et al., Adv. Mater. 32 (28), 2000797 (2020). These LCE lattice structures show greater strain-energy dissipation properties when compared to traditional, commercially available photocurable elastomer resins. These lattice structures also explored the possibility of tailorable energy dissipation, demonstrating variable strain energy densities in different loading axes. Nonetheless, these structures were unaligned, or polydomain, and therefore were unable to harness the key energy dissipation properties enabled by monodomain LCEs. There exist some DLP-based approaches to create monodomain LCE structures, but they are limited to 2D, planar geometries. See Y. Wang et al., “Printing Mosaics of Magnetically Programmed Liquid Crystal Directors for Reversibly Morphing Soft Matter.” arXiv, 2401.06590 (2024); and P. Mainik et al., Adv. Mater. Technol. 8 (23), 2300727 (2023). Other DLP approaches that produce 3D structures of monodomain LCE required the use of a brittle, glassy elastomer material, unsuitable for mechanical damping. See S. Li et al., Sci. Adv. 7 (30), eabg3677 (2021); and M. Tabrizi et al., ACS Appl. Mater. Interfaces 11 (31), 28236 (2019). Therefore, producing monodomain three-dimensional (3D) LCEs with favorable soft elastic response for mechanical damping remains a challenge.

Using extrusion-based AM processes, such as direct ink write (DIW), LCE mesogens can be aligned during printing as a result of the shear forces imparted on the material as it exits the dispensing nozzle. Mistry et al. used DIW to manufacture blocks of monodomain LCE that are capable of dissipating large quantities of strain energy at relatively constant levels of stress. See D. Mistry et al., Nat. Commun. 12 (1), 1 (2021). That work highlights the rate dependence of LCE's energy dissipation capabilities. In particular, Misty et al. demonstrated that the efficiency of dissipation increases as the strain rate increases. Furthermore, DIW presents a better alignment technique than DLP because DIW allows for increased LCE mesogen alignment and associated directional soft elasticity in printed LCE structures. While this research highlights the potential of monodomain LCE for energy dissipation, the use of solid, non-porous architectures fails to utilize the complete 3D design space afforded by DIW for mechanical damping.

### SUMMARY OF THE INVENTION

The present invention is directed to a method to fabricate an aligned, monodomain liquid crystal elastomer (LCE) structure for energy dissipation, comprising providing an oligomerized LCE ink comprising a plurality of mesogens, printing a filament of the LCE ink according to a pre-determined pattern using an extrusion-based printer, curing the printed LCE ink by exposure to ultraviolet light, thereby fixing the alignment of the plurality of mesogens in the printed LCE ink, and repeating the printing and curing steps layer-by-layer to build a three-dimensional aligned, monodomain LCE lattice structure. The invention is further directed to a method for damping of an applied mechanical load, comprising providing a three-dimensional monodomain LCE lattice structure comprising filaments of LCE mesogens which are at least partially aligned in a mechanical loading direction, and applying a mechanical load in the mechanical loading direction, whereby the at least partially aligned mesogens dampen the applied mechanical load. The invention is further directed to a mechanical damper, comprising a three-dimensional LCE lattice structure configured to absorb an impulse load, wherein the LCE comprises a plurality of mesogens that are at least partially aligned in an applied impulse loading direction. The invention is further directed to a vibration isolator, comprising a three-dimensional LCE lattice structure configured to dampen the transmission of vibrations over a frequency range, wherein the LCE comprises a plurality of mesogens that are at least partially aligned in an applied vibration direction.

Additively manufactured monodomain LCE lattice structures exhibit remarkable mechanical energy dissipation properties across a range of strain rates from quasi-static to dynamic. Monodomain LCEs exhibit a soft elastic response at high strain rates as a result of their unique molecular structure making them ideal candidates for both quasi-static and dynamic mechanical damping. During quasi-static testing, exemplary LCEs displayed an improved soft elastic response as a result of mesogen rotation. This more efficient dissipation is balanced by the deterioration in performance over large cyclical loads due to the slow viscoelastic reorientation of the mesogens to an aligned monodomain state. Shock testing of LCE lattices demonstrated lower cumulative energy transfer across multiple drop heights, leading to fewer rebounds in the system and significantly reduced energy dissipation time compared to silicone elastomer (SE) lattices. Furthermore, dynamic vibration testing of LCEs displayed a reduction in transferred energy at structural natural frequencies and full attenuation at high frequencies. LCEs have improved mechanical damping properties that can be combined with dampening architectures to maximize mechanical dampening of multiple loading types. Therefore, the ability to produce monodomain LCEs with increasing lattice customizability using AM enables new packaging and protective materials that can be designed to withstand a broad range of mechanical loading conditions.

### BRIEF DESCRIPTION OF THE DRAWINGS

The detailed description will refer to the following drawings, wherein like elements are referred to by like numbers.

FIGS. 1A-1C illustrate an approach for direct ink write (DIW) manufacturing of lattice architectures. FIG. 1A shows the chemical formulation of an exemplary LCE oligomer ink used for DIW printing of energy-dissipating lattice structures. FIG. 1B is a schematic illustration showing the DIW printing of an LCE cellular lattice structure, where alignment of the polymer chains along the printing direction is fixed using UV curing immediately after extrusion from a syringe. FIG. 1C shows top view and cross-section images of a SE cellular lattice structure, top left and bottom left respectively, and a monodomain LCE cellular lattice structure, top right and bottom right, respectively. Scale bar is 8 mm.

FIG. 2A is a graph showing FTIR absorbance sensitivity of LCE resins to increasing print speeds (mm/s). FIG. 2B is a graph of normalized height of the 4680 cm⁻¹ absorbance peak versus extrusion speed. FIG. 2C is a graph of strain relaxation as a function of increasing temperature and printing condition for LCE structures. FIG. 2D is a graph showing a linear relationship between FTIR normalized absorbance peak height and strain at 240° C.

FIG. 3 is a graph showing measured LCE line width and actuation strain as a function of printing speed.

FIG. 4 is a tan delta plot of LCE and SE at 25° C., indicating superior energy absorption capacity of LCE.

FIG. 5A illustrates lattice orientations and force directions for a cubic lattice structure. FIG. 5B illustrates lattice orientations and force directions for a hexagonal lattice structure.

FIGS. 6A-6D show quasi-static loading performance of monodomain LCE lattice architectures. FIG. 6A is an image of LCE cellular lattice structure under a compressive load test head with the structure oriented such that the loading direction aligns with the mesogen alignment in the fabrication direction. Scale bar is 8 mm. FIG. 6B is a graph of normalized compressive stress as a function of structure displacement (strain), comparing LCE to SE performance highlighting the damping region. FIG. 6C is a graph showing compressive stress as a function of structure displacement comparing LCE performance under cyclical loading indicating mesogen reorientation is required for repeatable cyclic loading response. FIG. 6D is a graph showing compressive stress as a function of structure displacement comparing SE performance under cyclical loading.

FIG. 7A is a schematic illustration of a drop test fixture for dynamic shock testing. FIG. 7B is a graph of 50 mm drop test response for LCE structures with key points time-stamped. FIG. 7C is a graph of 50 mm drop test response for SE structures with key points time-stamped.

FIG. 8 is a graph showing cumulative energy transfer of LCE and SE samples for multiple drop heights.

FIG. 9A is a schematic illustration of a high-frequency vibration test fixture. 1-accelerometer (Z₁) is used to measure the Z-axis acceleration of input during sine sweep and 2-accelerometer (Z₂) is used to measure the Z-axis acceleration of the “packaged” interior structure to observe energy transferred. FIG. 9B is a graph of energy transfer function as a result of the vibration frequency comparing LCE to SE across the complete tested range of 100 Hz to 4000 Hz. FIG. 9C is a graph of energy transfer function as a result of vibration frequency highlighting the differences in material performance between 150 and 1100 Hz.

### DETAILED DESCRIPTION OF THE INVENTION

Designing structures that effectively dissipate energy across various mechanical loading rates, including those from compression, shock, and vibration, poses a significant engineering challenge. Aligned, monodomain LCEs possess inherent anisotropic properties resulting from the macroscopic alignment of mesogens in their polymer backbone. The present invention is directed to aligned, monodomain LCE structures, and a method for the additive manufacturing of aligned, monodomain LCE structures, for example using an extrusion-based DIW printer, that have superior mechanical energy dissipation capabilities across a range of strain rates from quasi-static to dynamic. This multi-strain rate dissipation is enabled by both the printed lattice geometry and the monodomain LCE anisotropic properties. The performance of monodomain LCE lattice structures was tested in quasi-static and dynamic environments through compression testing, impact shock testing, and high-frequency vibration testing. The LCE structures outperformed identical geometries produced using traditional silicone elastomer (SE) materials in all three tested areas. Thus, aligned LCE materials have improved mechanical damping properties that can be combined with lattice architectures to maximize mechanical dampening of multiple loading types. With the ability to produce aligned LCE lattice structures with increasing customizability using AM, new packaging and protective materials can be designed to withstand targeted loading with increased efficiency.

### DIW of Cellular Lattice Structures

The production of aligned, or monodomain, LCEs remains a challenge. However, recent investigations of AM processes for LCE have led to the development of multiple viable methods for the fabrication and verification of simple monodomain LCE geometries. The most widely used AM process for preparing monodomain LCEs is direct ink write (DIW), where the shear forces generated during extrusion can be used to create a monodomain LCE with alignment in the printing direction. See D. J. Roach et al., Smart Mater. Struct. 27 (12), 125011 (2018); and C. P. Ambulo et al., ACS Appl. Mater. Interfaces 9 (42), 37332 (2017); which are incorporated herein by reference. As examples of the present invention, monodomain cellular LCE foam structures with varying porosities were fabricated using DIW.

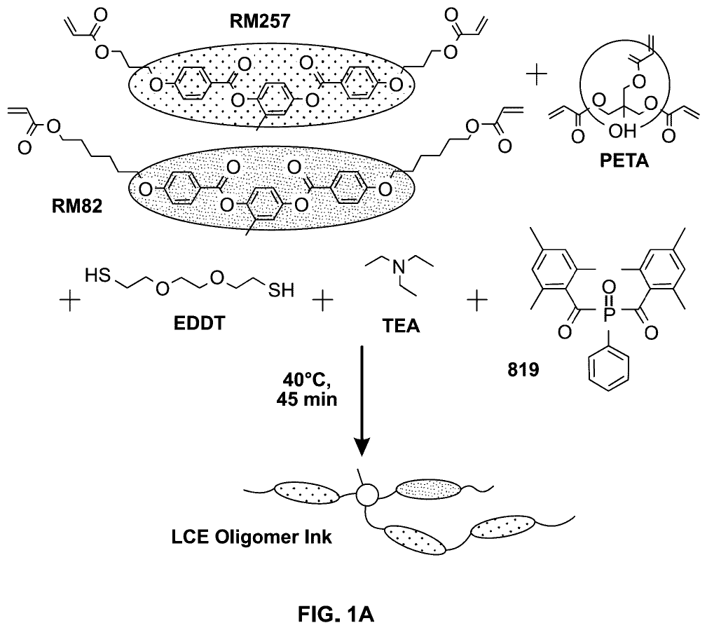

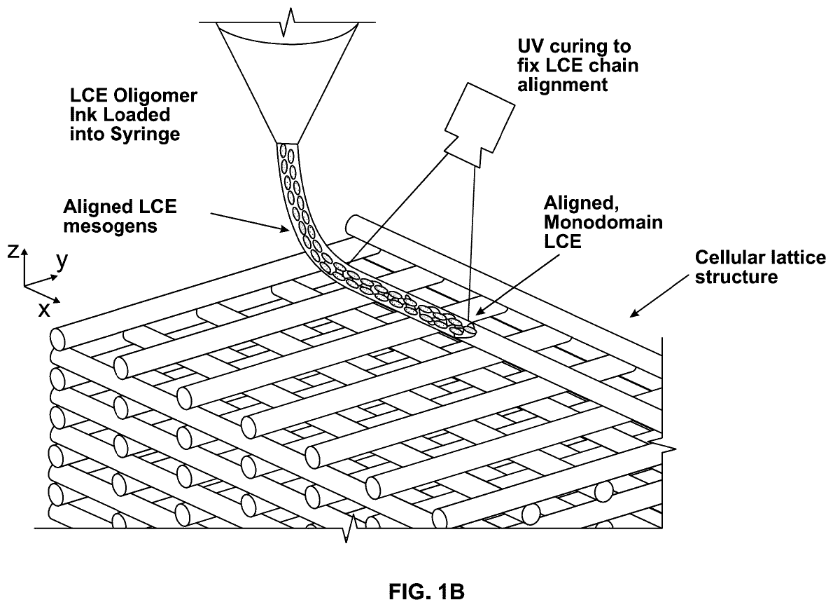

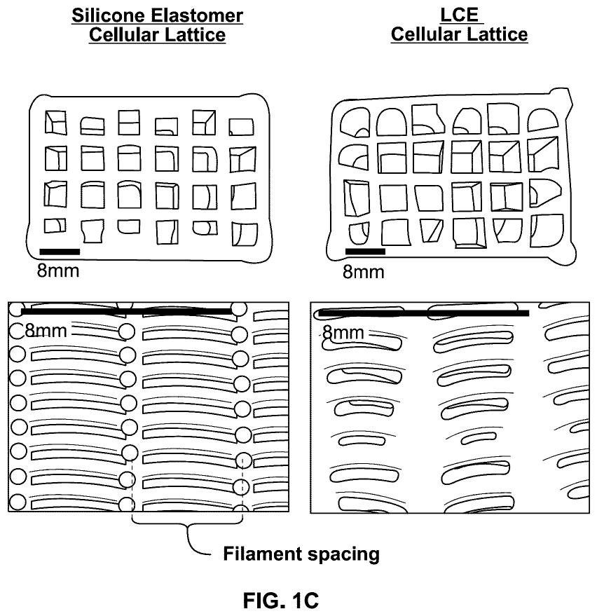

The chemical composition of an exemplary LCE ink, shown in FIG. 1A, was developed using approaches which have been investigated in previous works and applied to previous LCE research. See T. H. Ware et al., Science 347 (6225), 982 (2015); X. Peng et al., Adv. Mater. 34 (39), 2204890 (2022); M. O. Saed et al., Adv. Funct. Mater. 29 (3), 1806412 (2019); D. J. Roach et al., Smart Mater. Struct. 27 (12), 125011 (2018); L. McDougall et al., ACS Appl. Mater. Interfaces 15 (50), 58897 (2023); D. J. Roach et al., Adv. Funct. Mater. 32 (36), 2203236 (2022); and U.S. patent application Ser. No. 18/597,081, filed Mar. 6, 2024, which are incorporated herein by reference. The exemplary LCE ink was synthesized by following the procedure. First, two diacrylate liquid crystal mesogens, 2-methyl-1,4-phenylene bis(4-(3-(acryloyloxy) propoxy)benzoate (RM257) and 1,4-bis[4-(6-acryloyloxyhexyloxy)benzoyloxy]-2-methylbenzene (RM82), available from Wilshire Technologies (Princeton, NJ, USA), were mixed in a 75/25% weight ratio. Next, 25 wt. % thiol spacer [2,2′-(ethylenedioxy) diethanethiol (EDDT)], 3 wt. % of the tetrafunctional cross-linker [pentaerythritol triacrylate (PETA)], 5 wt. % photoinitiator [bis(2,4,6-trimethylbenzoyl)-phenylphosphineoxide (Irgacure 819)], and 2.5 wt. % inhibitor [butylated hydroxytoluene (BHT)] were introduced into the mixture. The solution was then heated to 100° C. and mixed as necessary to ensure homogeneity. After cooling to room temperature, 1 wt. % catalyst [tetraethylamine (TEA) in a 1:20 ratio with toluene] was added. The solution was then added to a planetary mixer and stirred at 2000 rpm for 2 minutes. The solution was then transferred to a 30 mL syringe and heated at 40° C. for 45 minutes for oligomerization to form a printable ink. After removal from the oven and cooling to room temperature, the LCE ink was ready for printing. The oligomerized LCE ink was then degassed, loaded into a syringe and extruded into structures using a DIW printer.

A custom-engineered DIW printer having computer-controlled motion stages was used to translate a build plate in the X-Y plane. A constant displacement syringe pump affixed to the Z-axis of a translating motion stage was used to print the oligomerized LCE ink in orthogonal filaments, as shown in FIG. 1B. Inks were printed at room temperature. During printing, the LCE mesogens are aligned by the shear forces exerted on the LCE ink extrudate during extrusion through the DIW nozzle. In general, the filaments can have any cross section (e.g., circular, square, rectangular), so long as the filaments are thin enough and the extrusion speed is high enough so that the resulting shear force can align the mesogens. After printing, the LCE ink was cured using a high-intensity UV light to fix the LCE mesogen chain alignment and ensure full polymerization of the printed ink.

As an example of the invention, 3D cellular lattice structures were produced with 10 layers of alternating 0°/90° filaments to create internal void regions in the structure, which increase the porosity. Each sample had a typical dimension of 164.5 mm² cross-sectional area and 16.5 mm thickness. The alternating filament direction is highlighted in FIG. 1B, where the DIW of a LCE lattice structure is illustrated. Materials were extruded using a 0.85 mm nozzle and the associated printing parameters were optimized to enable the spanning of gaps within the cellular structure. Structures were fabricated with filament spacings of 2.55 mm which is three times the bead thickness, which was equal to the nozzle diameter. To serve as a baseline for mechanical testing, an identical lattice architecture was prepared using a commercially available SE, polydimethysiloxane (PDMS). The LCE and SE inks have carefully tuned rheology which enables shape fixity and self-supporting structures during the printing and curing process. Top-down and cross-sectional images of the printed LCE and SE cellular lattice structures are shown in FIG. 1C, exhibiting similar geometry and porosity.

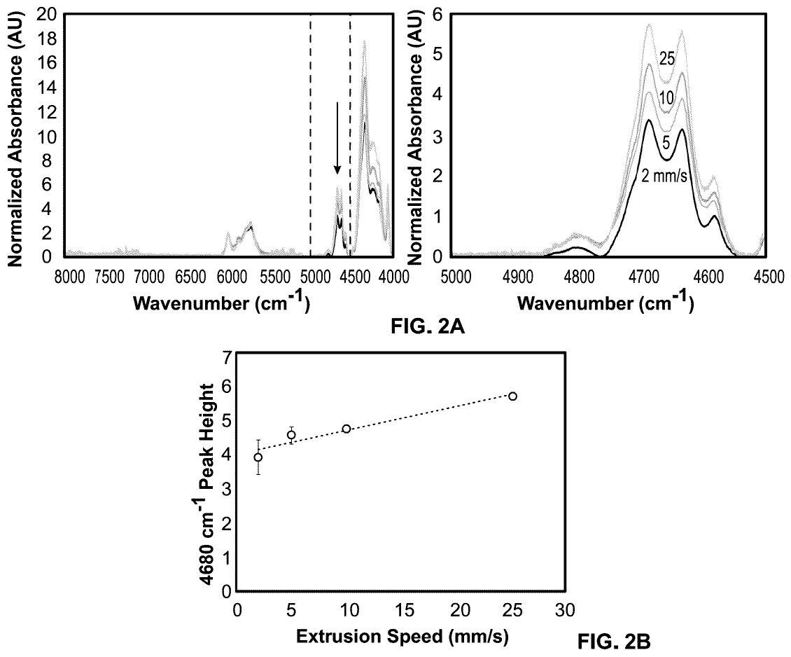

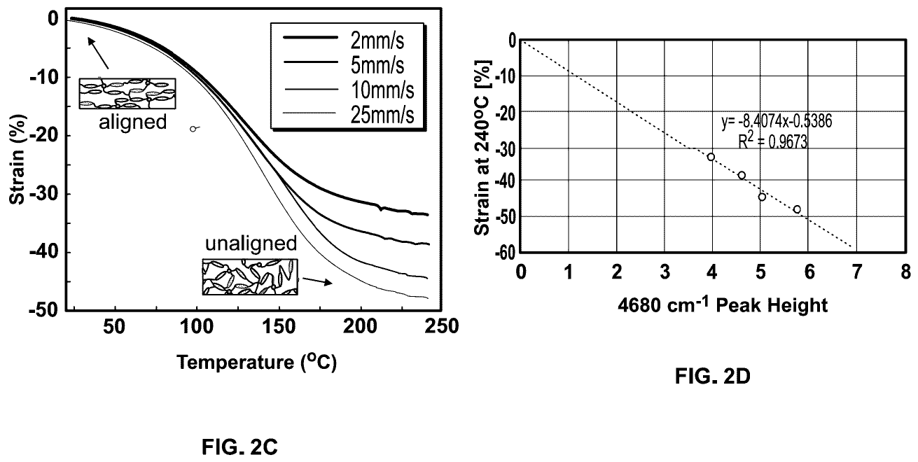

LCE alignment was verified using benchtop and in-situ FTIR characterization by tracking the 4680 cm⁻¹ absorbance peak and a flow-through characterization cell. See U.S. Pat. No. 11,833,762 to Cook et al., issued Dec. 5, 2023, which is incorporated herein by reference. FIG. 2A shows FTIR absorbance sensitivity of LCE resins to increasing print speeds. As shown in FIG. 2B, the normalized height of the 4680 cm⁻¹ absorbance peak increases with extrusion speed (and, therefore, extrusion shear force). FIG. 2C is a graph of strain relaxation as a function of increasing temperature and printing condition for the LCE structures. The large, reversible thermomechanical actuation is caused by mesogen rotation within the LCE, which confirms the expected monodomain alignment in the DIW extrusion direction. FIG. 2D is a graph showing a linear relationship between FTIR normalized absorbance peak height and strain at 240° C. Together, strain relaxation at elevated temperature is proportional to LCE polymer chain alignment and the observed FTIR spectral changes are dependent on alignment.

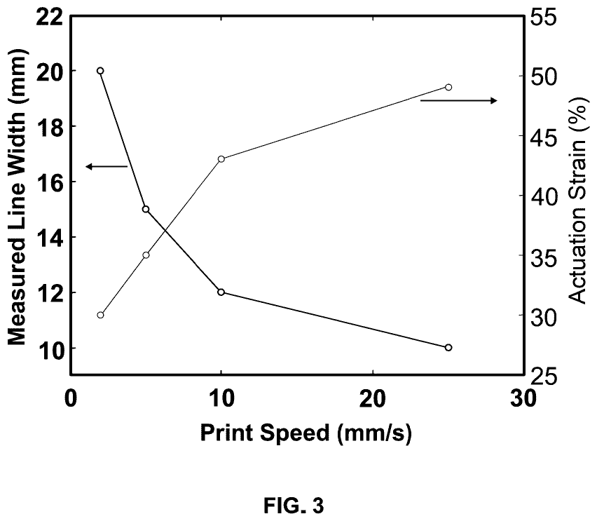

FIG. 3 is a graph showing measured LCE line width and actuation strain as a function of printing speed. Printing speed (and extrusion shear force) is well correlated with LCE polymer chain alignment as shown through FTIR measurements.

To further verify the alignment of the printed LCE, polar optical microscopy (POM) was used to observe the birefringence to the printed LCE when the alignment direction is rotated 45° relative to the polarizer. This indicated alignment as the sample transitions from light to dark when rotated from 45 to 90. The DIW fabrication process used has been thoroughly examined for the production of monodomain LCE using polarized optical micrographs (POMs) in the literature. See D. J. Roach et al., Smart Mater. Struct. 27 (12), 125011 (2018); Z. Wang et al., Addit. Manuf. 52, 102678 (2022); and D. Mistry et al., Nat. Commun. 12 (1), 1 (2021).

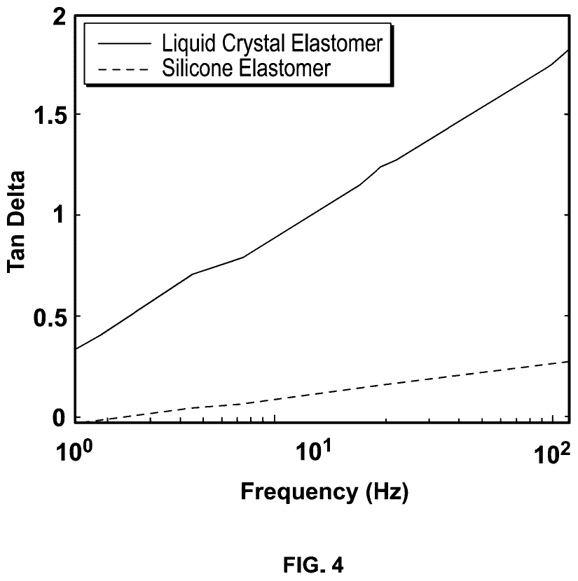

Dynamic mechanical analysis (DMA) was conducted on LCE and SE samples to determine each material's potential for energy dissipation. Tan delta is the ratio of storage modulus to the loss modulus, which can be used as an indicator for materials damping capacity at different temperatures and frequencies. The higher the tan delta, the more efficiently the material can absorb energy. See A. Hotta and E. M. Terentjev, Eur. Phys. J. E 10 (4), 291 (2003); and A. Mittermiller, Rubber News Technical Notebook, May 17, 2021. FIG. 4 shows the tan deltas of LCE and SE at 25° C. across a frequency range of 1 Hz to 120 Hz. The LCE shows a significantly higher tan delta across the entire range of frequencies, which indicates superior damping ability at both low and high frequencies. However, when looking beyond standard temperature conditions, the damping advantage of mesogen rotation in LCE begins to deteriorate as it nears the nematic to isotropic transition temperature (T_{NI}). When material is held above T_{NI}, roughly 80° C. depending on the exact formulation and additives, mesogen rotation occurs prior to the structure being loaded and it will behave functionally similar to traditional elastomers. See M. O. Saed et al., Nat. Commun. 12 (1), 6676 (2021); R. Annapooranan et al., Adv. Funct. Mater. 34 (1), 2309123 (2024); and D. Mistry et al., Nat. Commun. 12 (1), 1 (2021). The high T_{NI} of the LCE allows for complete mesogen rotation which makes it ideal for damping at room temperature conditions.

### Mechanical Damping of LCE Lattice Structures

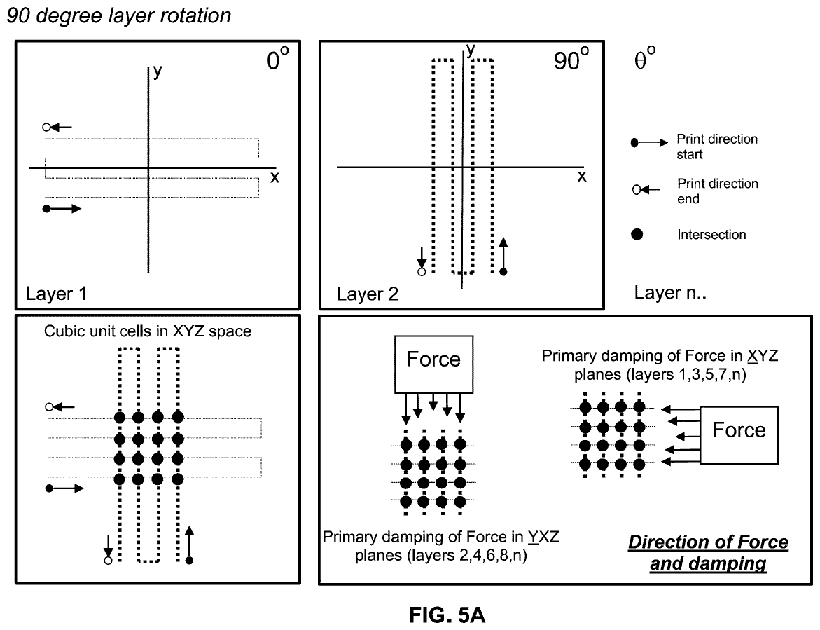

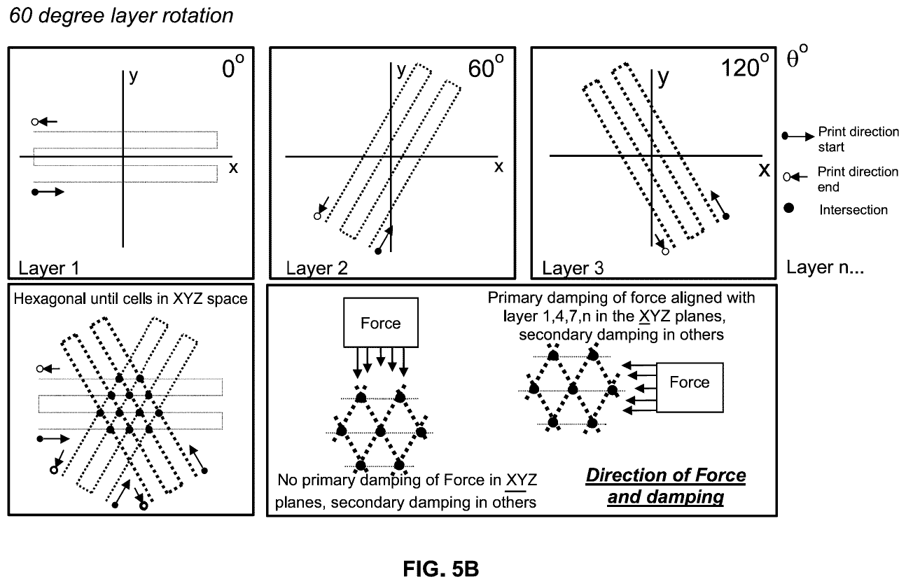

Damping is a function of lattice structure, LCE alignment, and force vector. In general, a wide variety of lattice structures, or 3D arrangements of repeated line patterns, can be printed. In FIG. 5A is shown a cubic lattice comprising printed lines or filaments with orientations that are rotated by 90° layer-by-layer in the XY printing plane. In this example, Layer 1 is printed with filaments comprising polymer chains aligned parallel to the X axis. Layer 2 is then printed with filaments comprising polymer chains aligned parallel to the Y axis. This pattern is repeated layer-by-layer until the 3D lattice structure is built. This pattern provides cubic unit cells in the XYZ space. If a compressive force is applied to this 3D cubic lattice structure parallel to the Y axis in the XY plane, the force will be damped primarily by the LCE polymer chains that are aligned parallel to the Y axis (i.e., in layers 2, 4, 6, 8 . . . ). Alternatively, if force is applied parallel to the X axis in the XY plane, primary damping of the force will occur in layers 1, 3, 5, 7 . . . ) in which the LCE polymer chains are aligned parallel to the X axis. In general, filaments can be placed in tension or compression with force loading.

In FIG. 5B is shown a hexagonal lattice comprising printed lines or filaments with orientations that are rotated by 60° layer-by-layer in the XY printing plane. In this example, Layer 1 is printed with lines comprising polymer chains aligned parallel to the X axis. Layer 2 is then printed with filaments comprising polymer chains aligned 60° to the X axis. Layer 3 is then printed with filaments comprising polymer chains aligned 120° to the X axis. This pattern is repeated until the 3D lattice structure is built. This pattern provides hexagonal unit cells in the XYZ space. If force is applied to this 3D hexagonal lattice structure parallel to the Y axis in the XY plane, no primary damping force occurs in the Y direction. Rather, only secondary damping forces occur resulting from the filaments printed 60° and 120° to the X axis in which the LCE polymer chains are only partially aligned with the loading direction of the applied mechanical force (i.e., in layers 2, 3, 5, 6 . . . ). Alternatively, if force is applied parallel to the X axis in the XY plane, primary damping will occur in filaments printed parallel to the X axis (i.e., in layers 1, 4, 7 . . . ) and secondary damping will occur in filaments printed 60° and 120° to the Y axis in which the LCE polymer chains are only partially aligned with the loading direction of the applied force (i.e., in layers 2, 3, 5, 6 . . . ).

### Quasi-Static Compression Performance

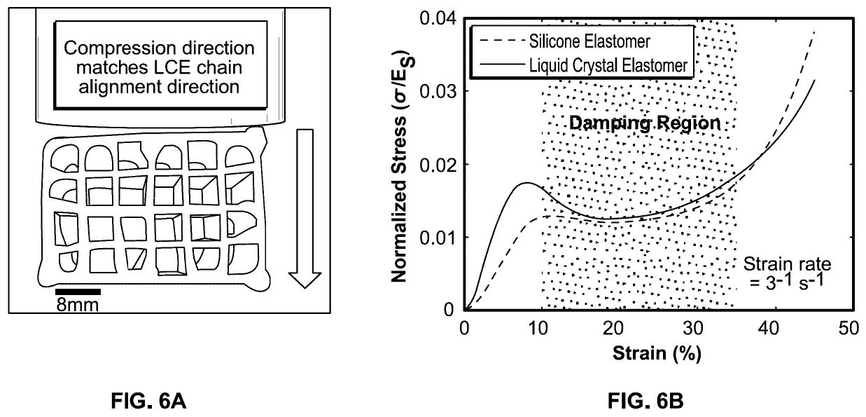

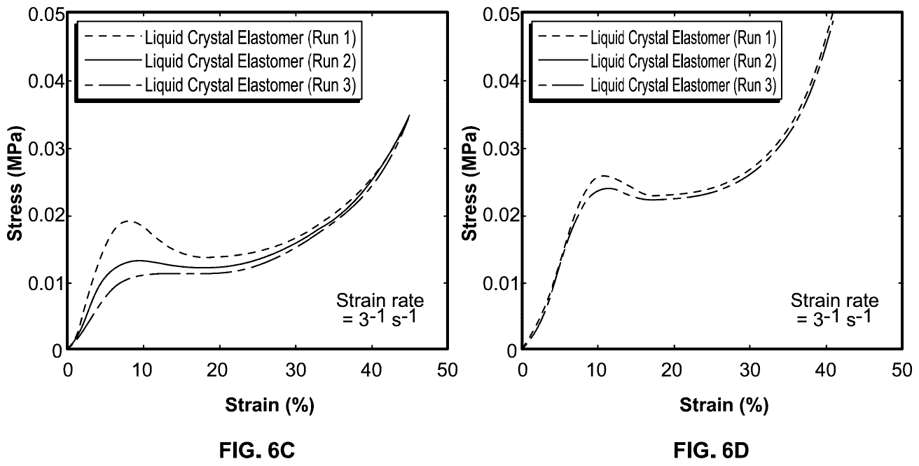

Typical materials for mechanical damping include elastomers, most notably SEs. See P. Mazurek et al., Chem. Soc. Rev. 48 (6), 1448 (2019). Low strain rate compression, typically referred to as quasi-static compression, is a key metric for determining a damper's efficacy for mechanical damping applications. Therefore, samples were loaded under a compressive test head, with the LCE extrusion direction, and associated mesogen alignment direction, aligned with the mechanical loading direction, as shown in FIG. 6A. Loading in the extrusion direction is critical for properly observing the effect of the alignment in LCE samples, as well as to provide a baseline orientation for all testing. Previous studies highlighted the rate-dependent behavior of LCE when subject to mechanical load. See C. P. M. Linares et al., J. Soft Matter 16 (38), 878 (2020); and D. Mistry et al., Nat. Commun. 12 (1), 1 (2021). Mistry et al. demonstrated a clear difference in dissipation efficiency between LCE and traditional elastomers as the strain rate increases past 10⁻¹ s⁻¹. For this reason, the tests were performed at a strain rate of 3⁻¹ s⁻¹ to confirm the performance difference between the samples.

As seen in FIG. 6B, the LCE lattice structure demonstrated similar quasi-static compression characteristics as the SE lattice structure of the same geometry. Three distinct regions of material response in both elastomers can be identified. In the first region, the materials exhibit similar linear-elastic responses. The second region, called the plateau or damping region, begins at the peak stress value (at about 10% strain) and extends through the constant stress plateau. The third region, called densification, begins at the end of the plateau region and is characterized by a sharp increase in stress as the material becomes fully compressed. All three of these regions have been observed in a range of elastomers across varying geometries, with the magnitudes distinct to each combination of material and geometry. Notably, the plateau strain, plateau length, and densification regions of both LCE and SE display similar values, demonstrating a similar elastic response as a result of the cellular geometry. See H. Kim et al., Mater. Today Commun. 35, 106417 (2023). These three response regions were also seen by Linares et al. when a uniaxial tension load was applied to LCE structures perpendicular to the mesogen chain alignment. See C. P. M. Linares et al., J. Soft Matter 16 (38), 878 (2020). Conversely, FIG. 6B shows the response when applying compressive loads parallel to the alignment direction, indicating that the macroscopic transformation of the chains can occur in opposite directions for opposite loading types, i.e., transforming from aligned to unaligned polymer chains when compressed, and vice versa for tensile loading.

The LCE structures demonstrate a significant drop in the measured stress after the peak stress was reached. This indicates the transition from the relaxation of the LCE polymer chains to mesogen rotation. This mesogen rotation as the material enters the plateau region leads to a 33.0% decrease in internal stress from the peak stress, compared to a 6.9% decrease seen in SE structures. This larger plateau region led to a larger strain percentage at a significantly lower applied force and, therefore, lower internal stress given identical cross sections. The observed stress value as the plateau region ends in LCEs is roughly equivalent to the value of the peak stress at the start of the plateau region, leading to the conclusion that all of the strain energy incurred is fully dissipated by the occurrence of mesogen rotation.

When cyclically loading LCE structures, a deterioration in the peak stress at the beginning of the plateau region was observed where the maximum stress decreases before soft elasticity is observed, as shown in FIG. 6C. The deterioration of the force required to reach soft elasticity in LCEs is primarily caused by slow reorientation of the mesogens to the monodomain state after loading. See A. E. H. Chehade et al., “Finite element modeling of viscoelastic liquid crystal elastomers,” Open Access Publications from the University of California, vol. UC Berkeley, p. 37, December 2023. Continuation of cyclic loading did not lead to further softening of the LCE. The absence of any peak stress prior to the plateau region is indicative of a fully stress softened structure, such that no mesogen rotation is occurring when the material is loaded. This can be mitigated by thermally recovering monodomain order via realigning the mesogen by heating the LCE above its nematic-to-isotropic transition temperature T_{NI} and allowing it to passively cool between loadings. This differs from the SE structure results shown in FIG. 6D, where all cyclic loads had nearly identical responses.

### Dynamic Impact Performance

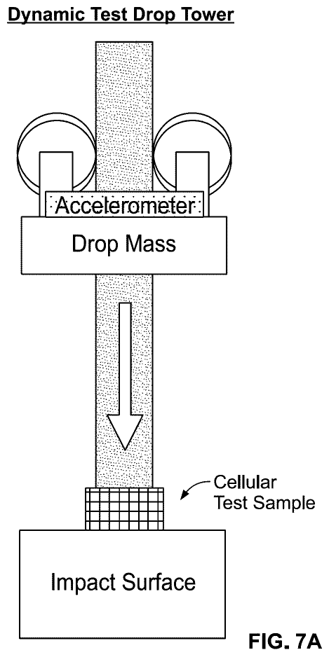

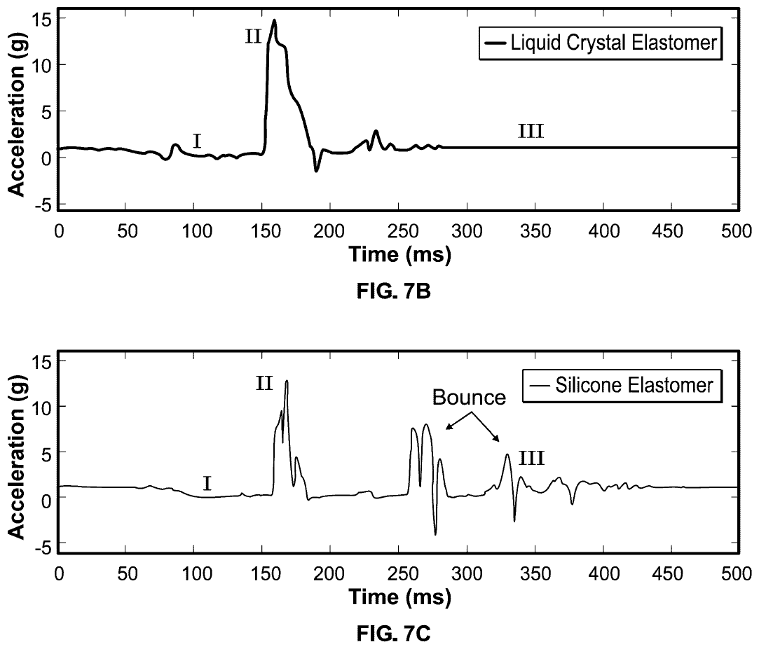

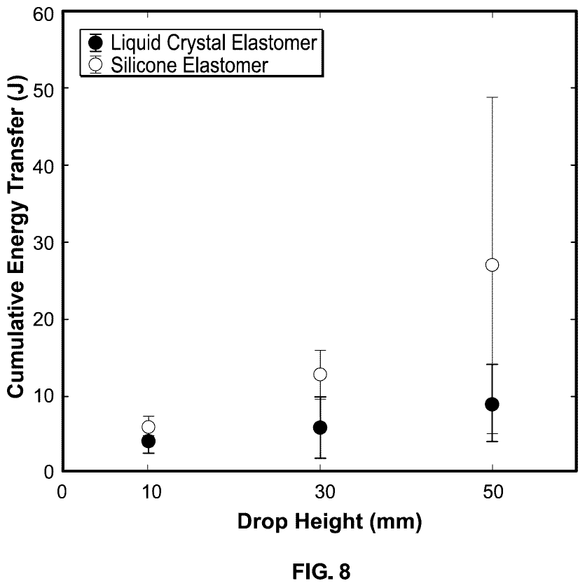

Drop tests were conducted to better understand the effect of the mesogen reorientation period observed during quasi-static cyclic loading on the total dissipative capacity of LCE. A drop test tower was constructed, as shown in FIG. 7A. Here, a known mass with a securely attached accelerometer was dropped onto the sample. In the case of the LCE lattice sample, the LCE mesogens are aligned in the vertical drop direction. The accelerometer was calibrated such that vertical accelerations were positive and output 1 g at rest. Experiments were conducted from drop heights of 10 mm, 30 mm, and 50 mm in order to apply different impulse magnitudes to the structures.

FIGS. 7B and 7C show the acceleration response of the LCE and SE cellular structures with images of key points in time during the drop testing. This data was filtered to reduce signal noise caused by shockwaves in the system. Location I shows the known mass experiencing freefall where the accelerometer reading reaches 0 g. Location II shows the moment of impact where the acceleration rapidly increases as the cellular structures dampen the impact. For drops above 10 mm onto SE samples, multiple freefall periods were observed after the initial impact. This is caused by rebounding off the SE test structure in the Z-direction. This rebound in the system is caused by the inherent stiffness of the SE not allowing for elastic deformation, and the SE lattice structure returning to its initial state after momentary rotation, causing the platform to rebound and the structure to return to its un-buckled state. Location III shows the system returning to a state of complete rest. The observed duration to reach this point varied drastically between tested LCE and SE structures. The unique molecular structure of monodomain LCEs enables enhanced energy dissipation, closer to that of ideal absorbers, when compared to traditional SE-based materials, evidenced by both the increased deceleration observed at the initial impact as well as the faster return to a state of complete rest.

As the drop height increases, the total potential energy of the system increases, requiring a greater dissipative capacity to bring the dropped mass to rest. As the energy of the system increases, a notable difference was observed between LCE and SE in each material's damping response. FIG. 8 shows the cumulative energy transfer of the system as the total energy increases with the drop height. The cumulative energy transfer is calculated as a function of the total change in kinetic energy of the system using the integral of the drop platform's acceleration relative to the volume of damping material used in the system. LCE structures demonstrate a linear increase as the total energy of the system increases, since its soft elastic region allows for a more efficient dissipation and buckling. This differs from SE structure's response, which increases more drastically as the total energy increases.

These results are supported by previous literature showing that aligned LCE behaves more closely to an ideal absorber during impact testing when compared to traditional elastomers. See D. Mistry et al., Nat. Commun. 12 (1), 1 (2021). In contrast to the LCEs' gradual increase in energy density, SE systems increased nearly exponentially as the drop height increased. SE structures do not plastically crumple and dissipate the impact in a similar manner as LCE but rebound energy throughout the system until it reaches a state of rest at a later time compared with LCE structures. This reiterates what was seen in quasi-static testing where the stiffness of the SE allows for an initially higher peak and total stress but fails to perform as efficiently as the LCE in the soft elastic plateau region. An increased deceleration response was observed in LCE samples as well, which would contribute to both the system's increased return to rest and the effectiveness of the dissipation response. When calculating the changes to velocity and position over the test duration of 50 mm drops with SE samples, it was found that nearly half of the kinetic energy was dampened during the initial impact with the sample. This compares poorly to the LCE samples at the same drop height, which dampened nearly all of the kinetic energy of the system at the initial impact.

### Dynamic Vibration Performance

In addition to shock, vibration is another method commonly used for probing the dynamic characteristics of materials and structures. Vibration testing elucidates further information about samples, such as natural frequencies and attenuation regions. Natural frequencies are critical for engineering applications as this is where failure is most likely to occur due to decreased energy absorption as well as environmental simulation of possible uses for the cellular lattice structures. By addressing the known natural frequencies of the material in the design stage, the chance of failure during product implementation can be mitigated to an acceptable risk level. Previous literature has demonstrated that vibration isolation can be achieved by adjusting structural geometries. See H. Hong et al., ACS Appl. Mater. Interfaces 16 (14), 17965 (2024). Therefore, the effect of structural geometry as well as material properties of the LCE structures was investigated. A vibration fixture was designed to measure the effect of monodomain LCE alignment on dynamic vibration attenuation. A schematic illustration of the vibration fixture is shown in FIG. 8A. A multi-layer structure was placed on a vibration table, as seen in other works. See D. Wang and R. Yang, J. Vib. Control 25 (9), 1536 (2019); and H. Hong et al., ACS Appl. Mater. Interfaces 16 (14), 17965 (2024). A vibration table applied a dynamic load to the multi-layer structure. The load was transferred to the top plate, called the transmissivity fixture, via bolted rods. The control structure is a rigid elastomer structure that remains constant throughout experimentation. Between the test sample and the control structure is an interior plate which is able to vibrate freely during testing. Two accelerometers are placed at key locations in the testing setup. The first accelerometer, labeled Z₁, is placed on the vibration table to measure the input signal. The second accelerometer, labeled Z₂, is placed on the interior plate and measures the signal transmitted through the test sample. A sine sweep test was conducted ranging from 100-4000 Hz with a ramp of 133 Hz/sec.

The transfer function (TF) is calculated using the difference in acceleration between the input acceleration a(f)ᵢₙₚᵤₜ and the interior plate acceleration a (f) output and is used to calculate the change in energy transferred from the input/transmissibility fixture across a frequency ramp using Equation 1. TF values above 1 indicate input energy being transferred to the interior plate. As a result, TF is able to quantify the damping of input energy.

$$TF ( f ) = \sqrt{{a ( f )}_{input}^{2} + {a ( f )}_{output}^{2}} \qquad ( 1 )$$

As seen in FIG. 8B, the cellular structure has multiple locations where the TF rapidly increases and spikes for both the low frequency (LF) regime below 2,000 Hz and high frequency (HF) regime above 2,000 Hz. These locations indicate natural frequencies inherent to the cellular structures. Importantly, regions where these natural frequencies occur for LCE and SE structures demonstrate the natural frequencies that are inherent to the geometry, rather than from material properties. Others have shown how damping can expanded using advanced geometries. See A. Singh and N. Karathanasopoulos, Thin-Walled Struct. 198, 111618 (2024); and H. Fu et al., Compos. Struct. 323, 117510 (2023). Nonetheless, the TF for LCE is markedly lower at these structural natural frequency locations, indicating superior damping as a result of the energy dissipation occurring during mesogen rotation in the LCE. Furthermore, the TF is below 1 for the entire HF regime meaning that LCE cellular structures provide full damping, also known as attenuation, above 700 Hz. In contrast, SE cellular structures exhibit multiple natural frequencies, even at higher frequency. To further examine the increased dissipation of the LCE material, the natural frequencies of the structural geometries were more closely examined. Between 180 and 230 Hz, LCE dampened 15.3% more effectively than the identical SE structures. In the largest geometric natural frequency range where most total energy transfer was observed, between 360 and 410 Hz, LCE structures dampened 57.8% more effectively than compared silicone structures.

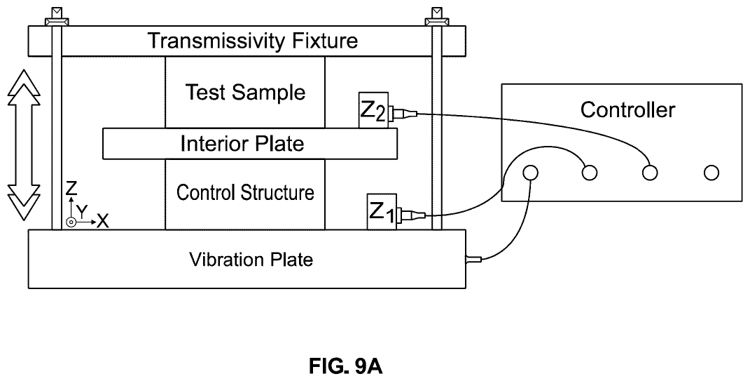

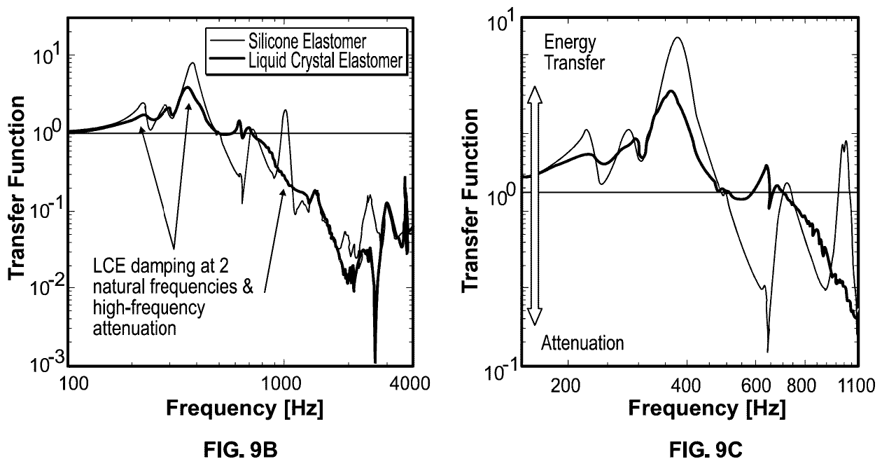

A natural frequency was identified in LCE structures during testing that was independent of the natural frequencies of the geometry, between 500 and 700 Hz as shown in FIG. 9C, which is hypothesized to be the natural frequency of the LCE material. While there is minimal energy transferred to the interior plate at this frequency through the LCE structure, this frequency range was fully attenuated by the SE structure. This can be directly contrasted to the hypothesized SE natural frequency range from 900-1080 Hz, where LCE fully attenuates across the range. A second SE natural frequency occurs from 2200 to 2800 Hz but is attenuated by both LCE and SE structures by the cellular architecture of the test structures.

In contrast to the degradation over repeated loading observed during quasi-static compression and impact testing, no decrease in vibration performance was observed in LCE structures. This is hypothesized to be a function of the magnitude of displacement applied to the structures, such that the vibration displacements are small enough in magnitude to be fully dissipated or transferred before aligning the mesogen units to activate the shape memory capability of the LCE, even over extended periods of loading. This lack of degradation paired with the improved performance of the LCE structures makes them an ideal candidate for vibration damping applications of high sensitivity items over extended periods, such as medical equipment transportation or aerospace applications.

The present invention has been described as aligned liquid crystal elastomer structures for mechanical damping. It will be understood that the above description is merely illustrative of the applications of the principles of the present invention, the scope of which is to be determined by the claims viewed in light of the specification. Other variants and modifications of the invention will be apparent to those of skill in the art.

1. A method to fabricate an aligned, monodomain liquid crystal elastomer (LCE) structure for energy dissipation, comprising:
providing an oligomerized LCE ink comprising a plurality of mesogens,
printing a filament of the LCE ink according to a pre-determined pattern using an extrusion-based printer,
curing the printed LCE ink by exposure to ultraviolet light, thereby fixing the alignment of the plurality of mesogens in the printed LCE ink, and
repeating the printing and curing steps layer-by-layer to build a three-dimensional aligned, monodomain LCE lattice structure.

2. The method of claim 1, wherein the lattice structure comprises a cellular lattice structure with tailorable porosity.

3. A method for damping of an applied mechanical load, comprising
providing a three-dimensional monodomain liquid crystal elastomer (LCE) lattice structure comprising filaments of LCE mesogens which are at least partially aligned in a mechanical loading direction, and
applying a mechanical load in the mechanical loading direction, whereby the at least partially aligned mesogens dampen the applied mechanical load.

4. The method of claim 3, wherein the LCE lattice structure is adapted to provide a mechanical damper configured to dampen an impulsive mechanical load.

5. The method of claim 3, wherein the LCE lattice structure is adapted to provide a vibration isolator configured to dampen the transmission of a vibrational mechanical load over a frequency range.

6. A mechanical damper, comprising a three-dimensional liquid crystal elastomer (LCE) lattice structure configured to absorb an impulse load, wherein the LCE comprises a plurality of mesogens that are at least partially aligned in an applied impulse loading direction.

7. A vibration isolator, comprising a three-dimensional liquid crystal elastomer (LCE) lattice structure configured to dampen the transmission of vibrations over a frequency range, wherein the LCE comprises a plurality of mesogens that are at least partially aligned in an applied vibration direction.
